(19) United States
(12) Patent Application Publication
(10) Pub. No.: US 2011/0221593 A1
(43) Pub. Date: Sep. 15, 2011

(54) APPARATUS AND METHOD FOR DYNAMIC LANE OPERATION IN MULTI-LANE BASED ETHERNET

(75) Inventor: Kyeongeun HAN, Daejeon (KR)

(73) Assignee: Electronics and Telecommunications Research Institute, Daejeon (KR)

(21) Appl. No.: 12/907,487

(22) Filed: Oct. 19, 2010

(30) Foreign Application Priority Data
Mar. 12, 2010 (KR) 10-2010-0022050

(51) Int. Cl. G08B 21/00; H04L 12/26

(52) U.S. Cl. 340/540; 370/230

(57) ABSTRACT

Provided is a method and apparatus for a dynamic lane operation that may determine a number of necessary lanes in a current network state according to an amount of input traffic based on queue information and monitored traffic information for a lane operation in a multi-lane based Ethernet apparatus, and may control the determined number of lanes.

### CROSS-REFERENCE TO RELATED APPLICATION

This application claims the benefit of Korean Patent Application No. 10-2010-0022050, filed on Mar. 12, 2010, in the Korean Intellectual Property Office, the disclosure of which is incorporated herein by reference.

### BACKGROUND

1. Field of the Invention

The present invention relates to an apparatus and method for a dynamic lane operation that may dynamically determine a number of lanes in a multi-lane based Ethernet apparatus.

2. Description of the Related Art

Currently, 40 Gbps and 100 Gbps Ethernet communication standardization is ongoing as a high speed wideband transmission system. A multi-lane structure where a single high speed transmission link is configured using a plurality of lanes having a relatively low transmission rate has been adopted as a structure for 40 Gbps and 100 Gbps Ethernet. For this, the standard defines a common physical layer for 40 Gbps and 100 Gbps Ethernet. With respect to the respective 40 Gbps Ethernet and 100 Gbps Ethernet, the standard defines a number of Physical Coding Sublayers (PCSs) as four and 20, and defines a number of physical lanes per link as four and ten.

Multi-lane based Ethernet defines, as ten, a number of electrical lanes configured between a Physical Medium Attachment (PMA) layer and a Physical Medium Dependent (PMD) layer with respect to a 100 Gbps Ethernet apparatus, and defines, as four, the number of electrical lanes with respect to a 40 Gbps Ethernet apparatus. Here, each electrical lane may transfer data in correspondence to a plurality of optical lanes via the PMA layer.

A large capacity of data transmission system based on multiple lanes may dynamically utilize a bandwidth according to a particular purpose such as a fault control, a reduction of a power consumption, and the like, or a network circumstance by dynamically operating the number of lanes. A lane operation scheme based on a particular mechanism may need to be provided from a Media Access Control (MAC) upper layer to dynamically operate multiple lanes. A MAC lower layer may need to provide a scheme capable of applying the lane operation scheme determined in the MAC upper layer.

Accordingly, to provide a compatibility with respect to multi-lane based Ethernet and to perform an effective network management, there is a desire for a dynamic lane operation control mechanism that may effectively operate and control a number of lanes in an MAC upper layer according to a network state or a traffic state.

### SUMMARY

An aspect of the present invention provides a method and apparatus for a dynamic lane operation in a multi-lane based Ethernet apparatus.

Another aspect of the present invention also provides a method and apparatus for a dynamic lane operation that may dynamically operate a number of lanes in a high speed Ethernet apparatus having multiple lanes according to a network state or a traffic state.

Another aspect of the present invention also provides a method and apparatus for a dynamic lane operation that may use a number of lanes as dynamic lane operation information in a multi-lane based apparatus or system.

Another aspect of the present invention also provides a method and apparatus for a dynamic lane operation that may apply a traffic state to a number of lanes in a multi-lane based Ethernet apparatus.

Another aspect of the present invention also provides a method and apparatus for a dynamic lane operation that may calculate a number of necessary lanes based on information associated with a total number of lanes and traffic in a multi-lane based Ethernet apparatus.

Another aspect of the present invention also provides a method and apparatus for a dynamic lane operation that may utilize queue information for dynamic lane operation in a multi-lane based Ethernet apparatus.

Another aspect of the present invention also provides a method and apparatus for a dynamic lane operation that may dynamically change a number of lanes based on input traffic and queue information in a multi-lane based Ethernet apparatus.

According to an aspect of the present invention, there is provided an apparatus for a dynamic lane operation, including: a traffic monitoring unit to generate traffic information by monitoring an amount of traffic input during a predetermined period; and a lane manager to determine a number of necessary lanes based on the traffic information.

According to another aspect of the present invention, there is provided a method for a dynamic lane operation, including: generating traffic information by monitoring an amount of traffic input during a predetermined period; and determining a number of necessary lanes based on the traffic information.

### EFFECT

According to embodiments of the present invention, there may be provided a method and apparatus that may determine a number of necessary lanes in a current network state according to an amount of input traffic based on queue information and monitored traffic information for a lane operation, and may control the determined number of lanes, and thereby flexibly and effectively coping with a varying network environment.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a multi-lane based Ethernet structure for a dynamic lane operation according to an embodiment of the present invention;

FIG. 2 is a block diagram illustrating a configuration of a dynamic lane operation apparatus according to an embodiment of the present invention;

FIG. 3 is a flowchart illustrating a process of monitoring an amount of traffic in a dynamic lane operation apparatus according to an embodiment of the present invention;

FIG. 4 is a flowchart illustrating a process of managing a queue in a dynamic lane operation apparatus according to an embodiment of the present invention;

FIG. 5 is a flowchart illustrating a process of managing a number of lanes in a dynamic lane operation apparatus according to an embodiment of the present invention;

FIG. 6 is a flowchart illustrating a process of monitoring an amount of traffic in a dynamic lane operation apparatus according to another embodiment of the present invention; and

FIG. 7 is a flowchart illustrating a process of managing a number of lanes in a dynamic lane operation apparatus according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to an embodiment of the present invention, there is provided a method and apparatus for a dynamic lane operation that may dynamically determine a number of lanes based on a network state or a traffic state in a multi-lane based Ethernet apparatus.

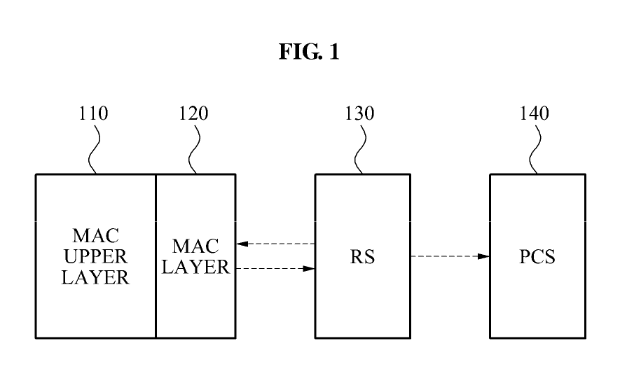

FIG. 1 is a diagram illustrating a multi-lane based Ethernet structure for a dynamic lane operation according to an embodiment of the present invention.

Referring to FIG. 1, the multi-lane based Ethernet structure may include a Media Access Control (MAC) upper layer 110, a MAC layer 120, a Reconciliation Sublayer (RS) 130, and a Physical Coding Sublayer (PCS) 140.

A dynamic lane operation apparatus included in the MAC upper layer 110 may monitor a network state to dynamically operate a number of lanes according to the monitored network state. The dynamic lane operation apparatus may determine a number of necessary lanes required in a current network state, based on the monitoring result.

The dynamic lane operation apparatus may transmit, to the RS 130 via the MAC layer 120, information associated with the determined number of lanes.

The RS 130 may receive lane change information and then adjust the changed number of lanes with a communicating Ethernet apparatus of a counter party. When the adjustment with respect to the changed number of lanes is completed, the RS 130 may transmit the lane change information to the PCS 140. The RS 130 may inform, using the MAC layer 120, the MAC upper layer 110 about that the number of lanes is changed.

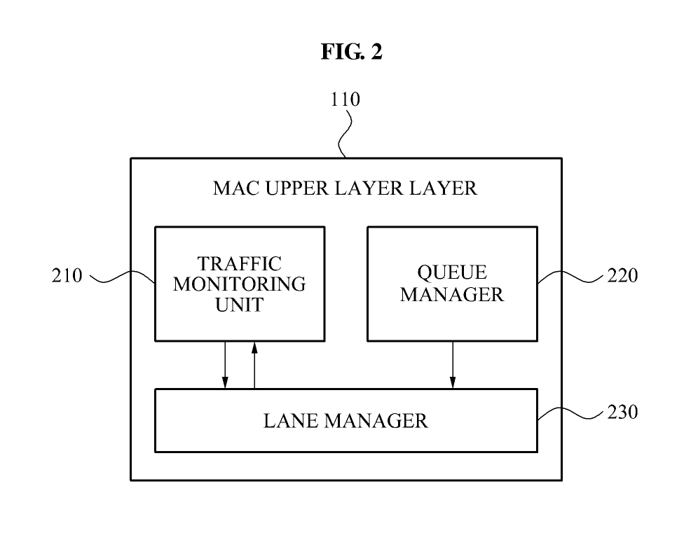

FIG. 2 is a block diagram illustrating a configuration of the dynamic lane operation apparatus according to an embodiment of the present invention.

Referring to FIG. 2, the dynamic lane operation apparatus included in the MAC upper layer 110 may include a traffic monitoring unit 210, a queue manager 220, and a lane manager 230.

The traffic monitoring unit 210 may monitor an amount of traffic input during a predetermined period T_{M}, and may inform the lane manager 230 about monitored traffic information. The amount of traffic input during the predetermined period may be calculated using a variety of algorithms and monitoring schemes. For example, the amount of input traffic may be calculated using length field information of a frame. Also, offered load information that is calculated based on a time or a period when traffic is monitored by the traffic monitoring unit 210, the amount of input traffic, and a total link transmission capacity may be utilized as the traffic information.

The queue manager 220 may monitor a current queue state. When a queue size being used exceeds a predetermined threshold based on the entire queue size, the queue manager 220 may inform the lane manager 230 about the above circumstance. In this instance, the predetermined threshold may vary based on a network state and a requirement.

The lane manager 230 may determine a number of necessary lanes required in a current network state, based on the traffic information received from the traffic monitoring unit 210. Initially, the lane manager 230 may determine a number of current necessary lanes based on traffic information monitored every period, and may determine whether to increase, decrease, or maintain a number of lanes currently being used. When the number of lanes being used needs to increase or decrease, the lane manager 230 may transmit information associated with the changed number of lanes to the RS 130 via the MAC layer 120.

When the amount of input traffic significantly increases and thereby an alarm signal indicating that the queue size exceeds the predetermined threshold is received from the queue manager 220, the lane manager 230 may transmit, to the traffic monitoring unit 210, a request signal for verifying a monitoring result with respect to current traffic.

When the request signal is received, the traffic monitoring unit 210 may generate traffic information based on an amount of traffic input during a corresponding period, and may transmit the traffic information. In this instance, the traffic monitoring unit 210 may maintain a monitoring period and a monitoring timer as is, and may normally update the traffic information to the lane manager 230 every period. Specifically, the lane manager 230 may determine the number of lanes required in the current network state, based on traffic monitoring information and queue information according to period or alarm information.

Based on the assumption that a transmission rate or a transmission capacity of each lane is the same, the lane manager 230 may determine the number of necessary lanes according to the following Equation 1.

$${N}_{r} = ⌊ ρ \times N ⌋ , ρ = \frac{{D}_{m}}{{C}_{l}} \qquad [ Equation 1 ]$$

Here, Nᵣ denotes the number of necessary lanes, ρ denotes the offered load, N denotes a total number of lanes, C₁ denotes a total link capacity, and Dₘ denotes an amount of traffic monitored during a predetermined period.

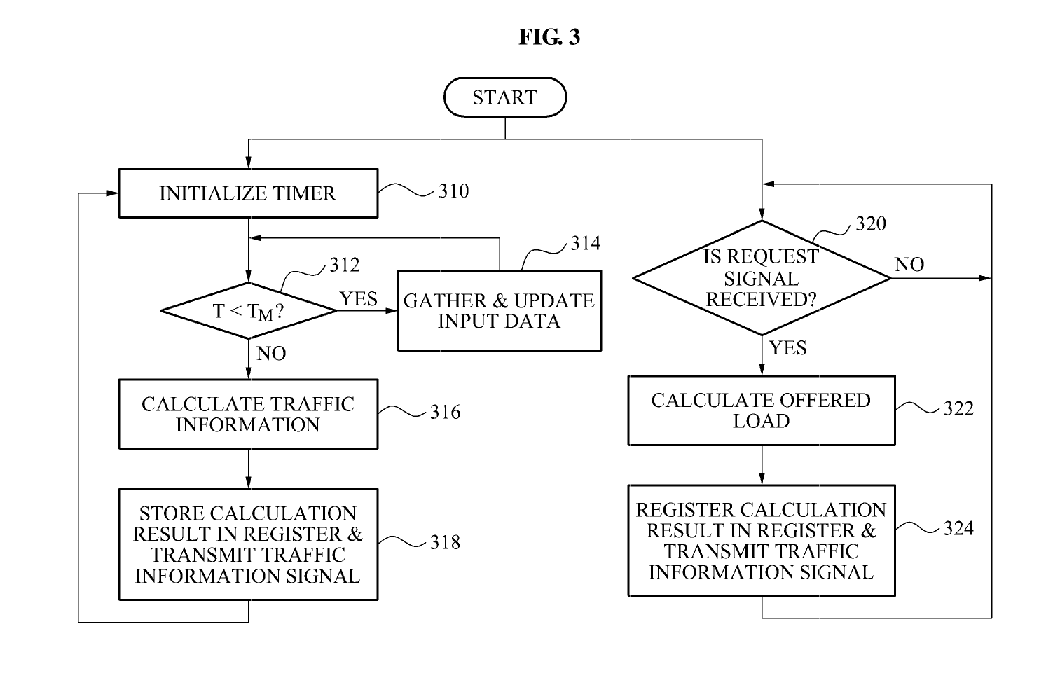

Even though the lane manager 230 utilizes the offered load as traffic information in Equation 1 to determine the number of necessary lanes, other parameters such as a channel utilization rate and the like may be applicable according to a control policy and a requirement, instead of the offered load. Hereinafter, an operation of the traffic monitoring unit 210, the queue manager 220, and the lane manager 230 will be further described with reference to FIG. 3 through FIG. 7.

Hereinafter, a dynamic lane operation method of dynamically determining a number of lanes based on a network state or a traffic state in a multi-lane based Ethernet apparatus will be described.

FIG. 3 is a flowchart illustrating a process of monitoring an amount of traffic in a dynamic lane operation apparatus according to an embodiment of the present invention.

In operation 310, the traffic monitoring unit 210 of the dynamic lane operation apparatus may initialize a timer. In operation 312, the traffic monitoring unit 210 may verify whether the timer set to operate during a time T_{M} is terminated.

When the timer is not terminated, the traffic monitoring unit 210 may gather and update an amount of input data during a range of the timer, for example, 0<T<T_{M} in operation 314.

Conversely, when the timer is terminated, the traffic monitoring unit 210 may calculate necessary traffic information based on the updated monitoring result in operation 316.

In operation 318, the traffic monitoring unit 210 may store the traffic information in a register, and transmit a traffic information signal indicating that the traffic information is updated.

As one example, in operation 318, only an offered load value is stored in the register as the traffic information. However, in addition to the offered load, a variety of traffic information using previous traffic information may be stored in the register.

Here, the timer may basically operate by applying T_{M} as a period. When using a timer that is automatically reset after a timer expiration, a process followed operation 312 may be repeatedly performed after performing operation 318, without going through operation 310.

In operation 320, the traffic monitoring unit 210 may monitor whether the request signal is received. The request signal denotes a signal transmitted from the lane manager 230 when the queue size being currently used exceeds the predetermined threshold and thereby there is a need to increase a number of lanes.

When the request signal is received from the lane manager 230, the traffic monitoring unit 210 may calculate the offered load or necessary traffic information at a current point in time T_{c} in operation 322. In operation 324, the traffic monitoring unit 210 may register the calculated offered load in the register as traffic information, and may transmit a traffic information signal indicating that the traffic information is updated.

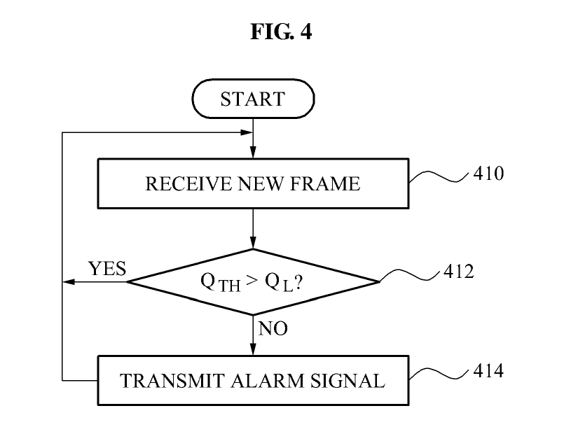

FIG. 4 is a flowchart illustrating a process of managing a queue in a dynamic lane operation apparatus according to an embodiment of the present invention.

When a new frame arrives at a queue in operation 410, the queue manager 220 of the dynamic lane operation apparatus may store the new frame in the queue and determine whether a current queue size exceeds a threshold in operation 412.

When the current queue size is less than or equal to the threshold, the queue manager 220 may repeatedly perform operations 410 and 412.

Conversely, when the current queue size is greater than the threshold, the queue manager 220 may transmit an alarm signal to the lane manager 230 in operation 414. The threshold with respect to the queue size being currently used may be utilized to prepare for a case where an amount of traffic significantly increases. When the amount of traffic significantly increases, a size of the queue may also significantly increase. This may cause a transmission delay. To flexibly utilize lanes according to an increase in the amount of traffic, the queue manager 220 may define the threshold and may generate the alarm signal when the queue size exceeds the threshold.

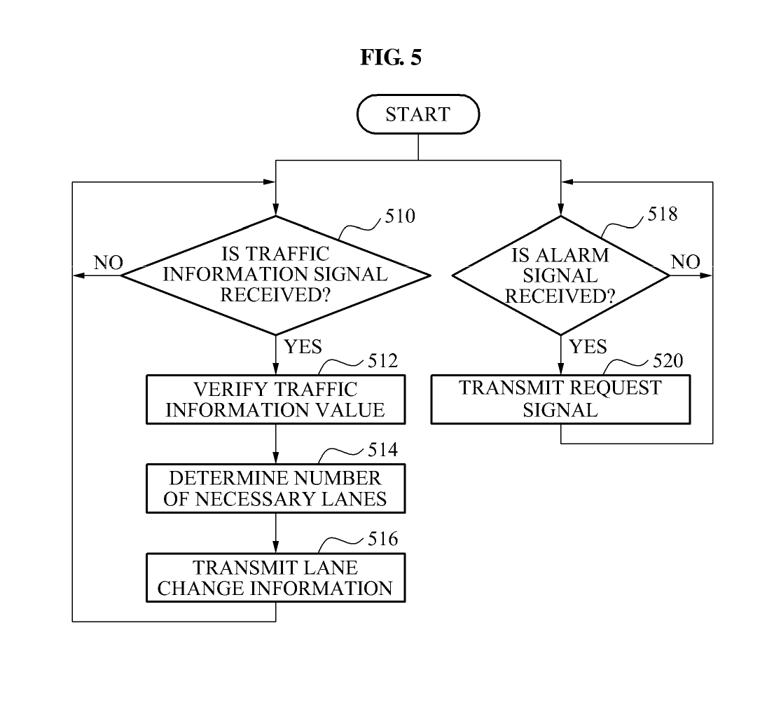

FIG. 5 is a flowchart illustrating a process of managing a number of lanes in a dynamic lane operation apparatus according to an embodiment of the present invention.

When a traffic information signal is received from the traffic monitoring unit 210 of the dynamic lane operation apparatus in operation 510, the lane manager 230 may verify a traffic information value stored in a register in operation 512.

In operation 514, the lane manager 230 may determine a number of necessary lanes based on the traffic information value. In operation 516, the lane manager 230 may transmit lane change information associated with the changed number of lanes to the RS 130 via the MAC layer 120. When a number of lanes being currently used is the same as the number of necessary lanes, the lane manager 230 may maintain the current number of lanes as is without transmitting the lane change information.

When an alarm signal is received from the queue manager 220 in operation 518, the lane manager 230 may generate a request signal and transmit the request signal to the traffic monitoring unit 210 in operation 520, so that the traffic monitoring unit 210 may update current traffic information or network information.

When the traffic monitoring unit 210 updates current traffic information or network information and then transmits a traffic information signal, the lane manager 230 may receive the traffic information signal and may change a number of necessary lanes and transmit lane change information associated with the changed number of lanes to the RS 130 via the MAC layer 120 through operations 510 through 516.

As another scheme of dynamically operating a number of lanes, when the queue manager 220 transmits an alarm signal, the lane manager 230 may utilize a total number of lanes for fast processing. For example, when the alarm signal is received, the lane manager 230 may set a total number of lanes as the number of necessary lanes without requesting the traffic monitoring unit 210 for separate information. The lane manager 230 may decrease a number of lanes based on an amount of traffic monitored every period.

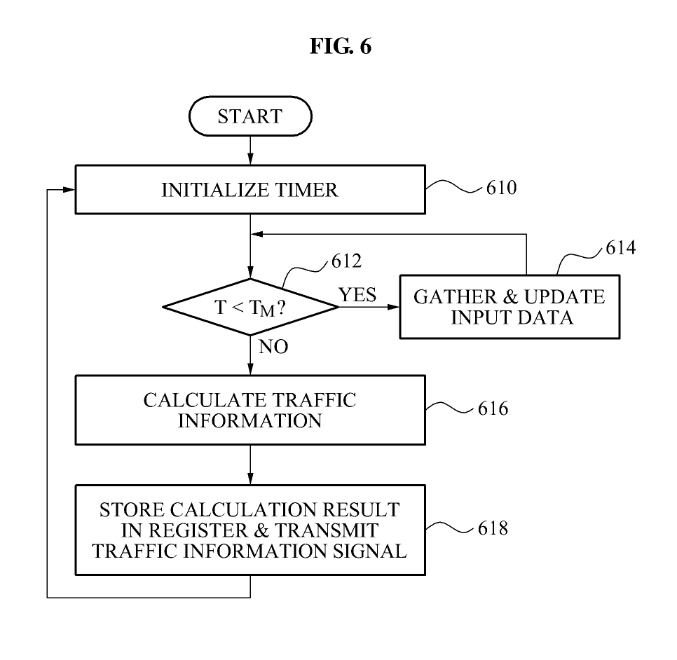

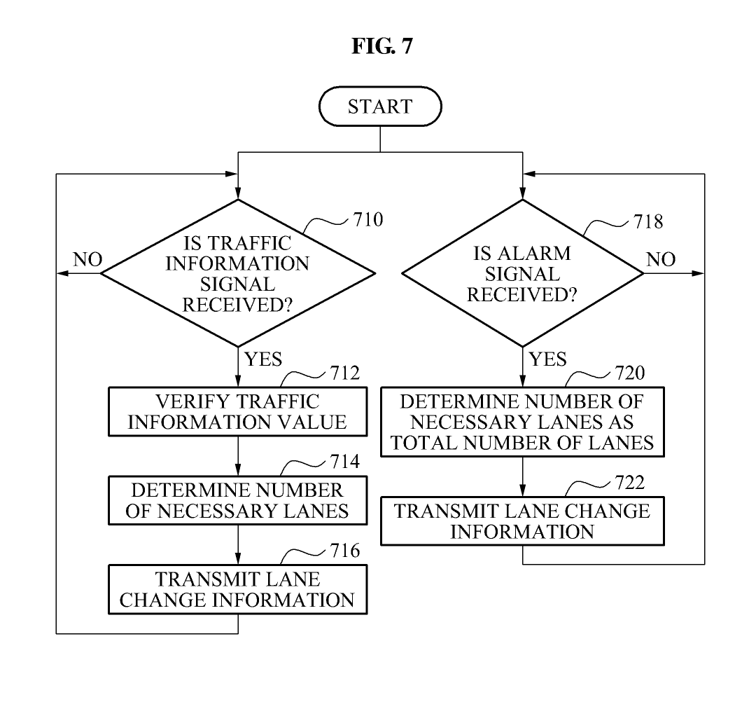

In the case of a scheme of using the total number of lanes when the alarm signal is generated, the queue manager 220 may operate alike as shown in FIG. 4. However, the traffic monitoring unit 210 and the lane manager 230 may operate as shown in FIG. 6 and FIG. 7.

FIG. 6 is a flowchart illustrating a process of monitoring an amount of traffic in a dynamic lane operation apparatus according to another embodiment of the present invention.

In operation 610, the traffic monitoring unit 210 of the dynamic lane operation apparatus may initialize a timer. In operation 612, the traffic monitoring unit 210 may verify whether the timer set to operate during a time T_{M} is terminated.

When the timer is not terminated, the traffic monitoring unit 210 may gather and update an amount of input data during a range of the timer, for example, 0<T<T_{M} in operation 614.

Conversely, when the timer is terminated, the traffic monitoring unit 210 may calculate necessary traffic information based on the updated monitoring result in operation 616.

In operation 618, the traffic monitoring unit 210 may store the traffic information in a register, and transmit a traffic information signal indicating that the traffic information is updated.

As one example, in operation 618, only an offered load value is stored in the register as the traffic information. However, in addition to the offered load, a variety of traffic information using previous traffic information may be stored in the register.

Comparing the embodiment of FIG. 6 with the embodiment of FIG. 3, it can be known that processing of a request signal is not considered in the embodiment of FIG. 6. When an alarm signal occurs, a total number of lanes may be all used without calculating the number of necessary lanes. In this case, the request signal from the lane manager 230 may not occur.

FIG. 7 is a flowchart illustrating a process of managing a number of lanes in a dynamic lane operation apparatus according to another embodiment of the present invention.

When a traffic information signal is received from the traffic monitoring unit 210 of the dynamic lane operation apparatus in operation 710, the lane manager 230 may verify a traffic information value stored in a register in operation 712.

In operation 714, the lane manager 230 may determine a number of necessary lanes based on the traffic information value. In operation 716, the lane manager 230 may transmit lane change information associated with the changed number of lanes to the RS 130 via the MAC layer 120. When the number of lanes being currently used is the same as the number of necessary lanes, the lane manager 230 may maintain the number of current lanes as is without transmitting the lane change information.

When an alarm signal is received from the queue manager 220 in operation 718, the lane manager 230 may determine the number of necessary lanes as a total number of lanes in operation 720. In operation 722, the lane manager 230 may transmit lane change information associated with the changed number of lanes to the RS 130 via the MAC layer 120. When the number of lanes being currently used is the same as the number of necessary lanes, the lane manager 230 may maintain the number of current lanes as is without transmitting the lane change information.

The dynamic lane operation method according to the above-described exemplary embodiments of the present invention may be recorded in computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for a dynamic lane operation, comprising:
a traffic monitoring unit to generate traffic information by monitoring an amount of traffic input during a predetermined period; and
a lane manager to determine a number of necessary lanes based on the traffic information.

2. The apparatus of claim 1, wherein when the number of necessary lanes is changed, the lane manager transmits information associated with the changed number of necessary lanes to a Reconciliation Sublayer (RS) unit via a Media Access Control (MAC) layer.

3. The apparatus of claim 1, further comprising:
a queue manager to monitor a queue state and to transmit an alarm signal when a queue size being used exceeds a predetermined threshold based on the entire queue size,
wherein when the alarm signal is received, the lane manager transmits, to the traffic monitoring unit, a request signal for verifying a monitoring result with respect to current traffic, and
when the request signal is received, the traffic monitoring unit generates the traffic information based on an amount of traffic input based on a point in time when the request signal is received, and transmits the generated traffic information to the lane manager.

4. The apparatus of claim 1, further comprising:
a queue manager to monitor a queue state and to transmit an alarm signal when a queue size being used exceeds a predetermined threshold based on the entire queue size,
wherein the lane manager determines the number of necessary lanes as a total number of lanes.

5. The apparatus of claim 1, wherein the traffic monitoring unit verifies the amount of traffic using length field information of an input frame.

6. The apparatus of claim 1, wherein the traffic information comprises offered load that is calculated by dividing the amount of traffic input during the predetermined period by a total link transmission capacity.

7. The apparatus of claim 6, wherein the lane manager determines, as the number of necessary lanes, a rounded-up value with respect to a multiplication result of the offered lane and the total number of lanes.

8. The apparatus of claim 1, wherein the traffic information comprises a channel utilization rate for the predetermined period.

9. A method for a dynamic lane operation, comprising:
generating traffic information by monitoring an amount of traffic input during a predetermined period; and
determining a number of necessary lanes based on the traffic information.

10. The method of claim 9, further comprising:
transmitting information associated with a changed number of necessary lanes to a RS via a MAC layer when the number of necessary lanes is changed by determining the number of necessary lanes.

11. The method of claim 9, further comprising:
monitoring a queue state and generating the traffic information based on an amount of traffic input based on a point in time when a queue size being used exceeds a predetermined threshold, when the queue size being used exceeds the predetermined threshold based on the entire queue size.

12. The method of claim 9, further comprising:
monitoring a queue state and determining the number of necessary lanes as a total number of lanes when a queue size being used exceeds a predetermined threshold based on the entire queue size,

13. The method of claim 9, wherein the generating comprises verifying the amount of traffic using length field information of an input frame.

14. The method of claim 9, wherein the traffic information comprises offered load that is calculated by dividing the amount of traffic input during the predetermined period by a total link transmission capacity.

15. The method of claim 14, wherein the determining comprises determining, as the number of necessary lanes, a rounded-up value with respect to a multiplication result of the offered lane and the total number of lanes.

16. The apparatus of claim 9, wherein the traffic information comprises a channel utilization rate for the predetermined period.
